(19) United States
(12) Patent Application Publication
(10) Pub. No.: US 2024/0386164 A1
(43) Pub. Date: Nov. 21, 2024

(54) METHOD AND SYSTEM FOR DETECTING STRUCTURAL DAMAGE BASED ON NExT-RECURRENCE PLOTS

(71) Applicant: ZHEJIANG UNIVERSITY, Hangzhou, Zhejiang (CN)

(72) Inventors: Yuanfeng DUAN, Hangzhou (CN); Qi ZHU, Hangzhou (CN); Hongmei ZHANG, Hangzhou (CN)

(73) Assignee: ZHEJIANG UNIVERSITY, Hangzhou, Zhejiang (CN)

(21) Appl. No.: 18/270,718

(22) PCT Filed: Apr. 21, 2022
(86) PCT No.: PCT/CN2022/088073

§ 371 Date: Jun. 30, 2023

(30) Foreign Application Priority Data
Mar. 16, 2022 (CN) 202210257028.8

(51) Int. Cl. G06F 30/23; G01M 5/00; G06F 111/10

(52) U.S. Cl. CPC G06F 30/23; G01M 5/0033; G06F 2111/10

(57) ABSTRACT

A method and system for detecting structural damage based on NExT-recurrence plots is provided. The method includes: acquiring a time-history signal of an acceleration response at each measured point of a structure under different damage conditions; processing the time-history signal of the acceleration response by using a NExT method to obtain cross-correlation function signals of acceleration responses at different measured structure points; performing recurrence plot processing on the cross-correlation function signals, and stacking generated recurrence plots to obtain three-dimensional recurrence plots; dividing the three-dimensional recurrence plots into a training set and a validation set; training and validating a convolutional neural network model through the training set and the validation set, respectively; detecting structural damage through a trained convolutional neural network model. Damage to the structure can be effectively detected and the accuracy and robustness of the detection can be improved to a maximum extent.

### CROSS REFERENCE TO RELATED APPLICATION

This patent application is a national stage of International Application No. PCT/CN2022/088073, filed on Apr. 21, 2022, which claims the priority to Chinese Patent Application No. 202210257028.8, entitled “Method and System for Detecting Structural Damage Based on NExT-Recurrence Plots” filed with China National Intellectual Property Administration on Mar. 16, 2022, the disclosure of which is incorporated by reference herein in its entirety.

### TECHNICAL FIELD

The disclosure relates to the technical field of structural damage detection, in particular to a method and system for detecting structural damage based on NExT-recurrence plots.

### BACKGROUND ART

Traditional damage identification algorithms based on structural dynamic characteristics usually require complex formula derivation to obtain a relationship between structural damage and structural dynamic characteristics, and the relationship between dynamic characteristics and damage varies for different structures. For complex structures, relevant theoretical derivations will greatly improve the threshold for using this method, and structural damage often affects fundamental frequency, mode, and modal curvature of the structure at the same time. Therefore, it is very difficult to achieve better accuracy for damage identification solely based on certain dynamic characteristics, and these characteristics are often disturbed and distorted during extraction process, and the accuracy of damage identification results needs to be improved.

On the basis of the traditional loss identification algorithm, relatively primitive acceleration response time-history data are used to better avoid loss of information, but the time-history data cannot directly characterize dynamic characteristics of the structure, and thus also have a defect. Recurrence plot samples generated by acceleration response are directly used for damage detection of a convolution neural network. The generated recurrence plot samples have the characteristics of inconsistency, that is, under the same damage condition, the generated recurrence plots are also very different. Therefore, the accuracy of the damage identification results is not high.

### SUMMARY

An objective of some embodiments of the present disclosure is to provide a method and system for detecting structural damage based on NExT-recurrence plots, which can effectively detect structural damage and maximize detection accuracy and robustness.

To achieve the above objective, the present disclosure provides the following solution.

A method for detecting structural damage based on NExT-recurrence plots, including:
acquiring a time-history signal of an acceleration response at each measured point of a structure under different damage conditions:
processing the time-history signal of the acceleration response by using a NExT method to obtain cross-correlation function signals of acceleration responses at different structure points:
performing recurrence plot processing on the cross-correlation function signals, and stacking generated recurrence plots to obtain three-dimensional recurrence plots;
dividing the three-dimensional recurrence plots into a training set and a validation set;
training and validating a convolution neural network model through the training set and the validation set, respectively;
detecting structural damage through a trained convolutional neural network model.

Alternatively, the acquiring a time-history signal of an acceleration response at each point of a structure under different damage conditions specifically includes:
building a numerical model of the structure;
generating a wind load by using a random wind field generated by a Kaimal spectrum;
calculating a buffeting wind force based on the wind load;
simulating different damage conditions of the structure through stiffness reduction;
loading the buffeting wind force onto the numerical model under different damage conditions to obtain the time-history signal of the acceleration response at each point of the structure under different damage conditions.

Alternatively, before performing recurrence plot processing on the cross-correlation function signal, the method further includes:
normalizing the cross-correlation function signal.

Alternatively, when an error calculation value of a cost function in the validation set is less than a predetermined target, it is determined that training of the convolutional neural network model is completed.

Alternatively, the method further includes:
generating each three-dimensional recurrence plot with a different average wind speed, a different damage condition and an acceleration response added with white noise of different signal-to-noise ratio in comparison with the training set and the validation set, to build a test set;
testing robustness of the trained convolutional neural network model through the test set.

The present disclosure also provides a system for detecting structural damage based on NExT-recurrence plots, including:
an acceleration response time-history signal acquisition module configured to acquire a time-history signal of an acceleration response at each measured point of a structure under different damage conditions;
a cross-correlation function signal acquisition module configured to process the time-history signal of the acceleration response by using a NExT method to obtain cross-correlation function signals of acceleration responses of different structural points;
a three-dimensional recurrence plot determination module configured to perform recurrence plot processing on the cross-correlation function signal, and stack generated recurrence graphs to obtain three-dimensional recurrence plots;
a division module configured to divide the three-dimensional recurrence plots into a training set and a validation set;
a training and validation module configured to train and validate a convolution neural network model through the training set and the validation set, respectively;
a structural damage detection module configured to detect structural damage through a trained convolution neural network model.

Alternatively, the acceleration response time-history signal acquisition module specifically includes:
a numerical model building unit configured to build a numerical model of the structure;
a wind load generation unit configured to generate a wind load by using a random wind field generated by a Kaimal spectrum;
a buffeting wind force calculation unit configured to calculate buffeting wind force based on the wind load;
a different damage condition simulation unit configured to simulate different damage conditions of the structure through stiffness reduction;
an acceleration response time-history signal acquisition unit configured to load the buffeting wind force onto the numerical model under different damage conditions to obtain the acceleration response time-history signal at each point of the structure under different damage conditions.

According to the specific embodiments provided by the present disclosure, the present disclosure discloses the following technical effects.

The present disclosure utilizes data processing method of NExT-recurrence plots to generate convolutional neural network training samples under different damage conditions, which can effectively realize structural damage detection under different wind loads, and has high robustness to white noises existing in the signal. Moreover, compared with the traditional machine learning algorithm, the convolutional neural network has inherent advantages in feature extraction of two-dimensional and higher-dimensional data, which can effectively improve its training efficiency and generalization ability in structural damage identification, and has better accuracy and lower training cost.

### BRIEF DESCRIPTION OF THE DRAWINGS

To describe the technical solutions in embodiments of the present disclosure or in the prior art more clearly, the accompanying drawings required in the embodiments will be briefly introduced hereinafter. Apparently, the accompanying drawings in the following description are only some embodiments of the present disclosure, and other drawings can be derived from these accompanying drawings by those of ordinary skill in the art without creative efforts.

Fig.1 is a flowchart of a method for detecting structural damage based on NExT-recurrence plots according an embodiment of the present disclosure.

Fig.2 is a structural diagram of a convolutional neural network.

### DETAILED DESCRIPTION OF THE EMBODIMENTS

In the following, the technical solutions in the embodiments of the present disclosure will be clearly and completely described with reference to the accompanying drawings in the embodiments of the present disclosure. Apparently, the described embodiments are only a part rather than all of the embodiments of the present disclosure. Based on the embodiments of the present disclosure, all other embodiments obtained by those of ordinary skill in the art without creative efforts belong to the protection scope of the present disclosure.

The objective of some embodiments is to provide a method and system for detecting structural damage based on NExT-recurrence plots, which can effectively detect structural damage and maximize the detection accuracy and robustness.

In order to make the above objective, features and advantages of the present disclosure clearer and more comprehensible, the present disclosure will be further described in detail below in conjunction with the accompanying drawings and detailed description.

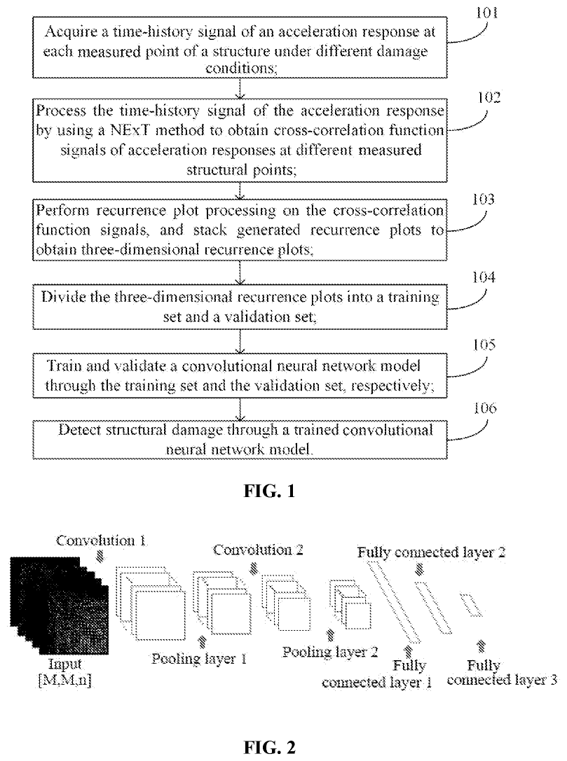

As shown in Fig.1, the method for detecting structural damage based on NExT-recurrence plots provided by the present disclosure includes the following steps S101-S106.

In step 101, a time-history signal of an acceleration response at each point of a structure under different damage conditions is acquired.

In step 102, the time-history signal of the acceleration response is processed by using a NExT method to obtain cross-correlation function signals of acceleration responses at different structural points.

In step 103, recurrence plot processing is performed on the cross-correlation function signals, and generated recurrence plots are stacked to obtain three-dimensional recurrence plots.

In step 104, the three-dimensional recurrence plots are divided into a training set and a validation set.

In step 105, a convolutional neural network model is trained and validated through the training set and the validation set, respectively.

In step 106, structural damage is detected through a trained convolutional neural network model.

Step 101 specifically includes following steps.

A numerical model of the structure is built to simulate a dynamic response of the structure suffering specific damage under wind load. In view of social security and cost, multiple damage conditions cannot be artificially introduced into a real structure, and instead, the damages are introduced into a numerical model of the structure, to which a simulated wind load is then applied.

According to a random wind field generated by the Kaimal spectrum, wind load is generated, fluctuating wind speeds at different positions of the structure are calculated, and buffeting wind force at different positions of the structure is calculated. Because static wind force does not produce acceleration, it is not considered. And, because average wind speed experienced by the real structure is random, for training samples, the average wind speed adopted during generating is different from that adopted during testing.

Considering that the real structure suffering damage usually occurs a reduction of stiffness, in this example, different damage conditions of the structure are simulated through stiffness reduction. Different damage conditions include different stiffness reduction rates and different damage positions, including single damage and multiple damages. Then, the buffeting wind force is applied to the numerical structure model under different damage conditions, to obtain the time-history signal of the acceleration response at each point of the structure under different damage conditions.

Steps 102-103 specifically include following steps.

Calculation formula of the cross-correlation function adopted in natural excitation technology is as follows:

$${R}_{AB} ( n ) = \frac{1}{N} {\sum }_{k = 0}^{N - 1} {S}_{AB} ( k ) exp [ j \frac{2 π kn}{N} ] , n = 0 , 1 , 2 , … , N - 1$$

where S_{AB} (k) is discrete cross-spectral density function, k is discrete frequency, and R_{AB} (n); is cross-correlation function at discrete time n. For example, for a structure with a degree of freedom of N, the result of the cross-correlation function generated by NExT technology is R₁₁, R₁₂, R₁₃, R₁₄, . . . , R_{1N}.

Before generating the recurrence plot, effective segments of the signal after NExT processing is normalized as follows:

$$\hat{R} = \frac{R - min ( R )}{max ( R ) - min ( R )}$$

where R is an effective segment of the signal; and \hat{R} is a normalized signal. The normalized signals are subjected to a recurrence plot process, to obtain N kinds of corresponding recurrence plots with a size of M×M, M being a number of points corresponding to the effective segments of the signal, and three-dimensional (M×M×N) recursive plots may be obtained by stacking N recurrence plots.

Steps 104-105 specifically include following steps.

70% of the three-dimensional recurrence plots is used as the training set, and the remaining 30% is used as the validation set for validation.

A convolutional neural network architecture established in this example is shown in Fig. 2. The construction of the convolutional neural network includes a convolutional layer, a pooling layer, and a fully connected layer. First, the convolutional layer is configured to extract features from matrix information, and the pooling layer is configured to reduce data dimension and occurrence of over-fitting phenomenon, and then the fully connected layer similar to a traditional neural network is configured to map the extracted features into target space.

In a last layer of the convolutional neural network, a mean square error function is selected as a cost function to calculate an error between predicted damage and actual damage, which may be expressed as a formula,

$${L}_{i} = \frac{1}{n} {\sum }_{j = 1}^{n} {( {f}_{ij} - {y}_{ij} )}^{2} ,$$

where fᵢⱼ represents a j-th value in a label corresponding to a i-th sample, Yᵢⱼ represents a j-th value in a damage prediction vector predicated by the convolution neural network for the i-th sample.

The convolutional layer adopts a ReLU activation function, which is expressed as a formula;

$$y = \{ \begin{matrix}α x & x < 0 \\ x & x \geq 0\end{matrix} ;$$

where α is a positive number close to 0, the gradient of the cost function for each training parameter is calculated through back propagation, and each parameter is updated by a mini-batch stochastic gradient descent algorithm.

The convolutional neural network is trained by using the training method and training set generated in the above steps until the error calculation value of the cost function for the verification set is less than a predetermined target, and the prediction accuracy of damage degree at each point meets requirements.

According to the above steps, a recurrence plot test sample set is generated, which has different average wind speeds and different damage conditions and has the acceleration response added with white noise of different signal-to-noise ratios, in comparison with the training set and validation set, and then robustness of the trained convolutional neural network is tested with the testing set.

The disclosure is used for performing non-destructive damage identification on structures in the field of civil engineering, and proposes a method of performing NExT processing on acceleration responses at multiple points of the structure in advance to obtain cross-correlation function signals, which are used to generate recurrence plots, so that the recurrence plots with the same damage have significant similar features, while the convolutional neural network is used for feature extraction. NExT processing can obtain similar structural signals from original structural signals, and recurrence plots can effectively characterize development trend and law of phase space trajectory over time. Compared with traditional machine learning algorithms, the convolutional neural network has inherent advantages in feature extraction of two-dimensional and higher-dimensional data, which can effectively improve the training efficiency and generalization ability of the network in structural damage recognition, resulting in a better accuracy and a lower training cost of the network.

The present disclosure also provides a system for detecting structural damage based on NExT-recurrence plots, including an acceleration response time-history signal acquisition module, a cross-correlation function signal acquisition module, a three-dimensional recurrence plot determination module, a division module, a training and validation module, and a structural damage detection module.

The acceleration response time-history signal acquisition module is configured to acquire a time-history signal of an acceleration response at each point of a structure under different damage conditions.

The cross-correlation function signal acquisition module is configured to process the time-history signal of the acceleration response by using a NExT method to obtain cross-correlation function signals of acceleration responses of different structural points.

The three-dimensional recurrence plot determination module is configured to perform recurrence plot processing on the cross-correlation function signal, and stack generated recurrence plots to obtain three-dimensional recurrence plots.

The division module is configured to divide the three-dimensional recurrence plots into a training set and a validation set.

The training and validation module is configured to train and validate a convolutional neural network model through the training set and the validation set, respectively.

The structural damage detection module is configured to detect structural damage through a trained convolutional neural network model.

The acceleration response time-history signal acquisition module specifically includes a numerical model building unit, a wind load generation unit, a buffeting wind force calculation unit, a different damage condition simulation unit and an acceleration response time-history signal acquisition unit.

The numerical model building unit is configured to build a numerical model of the structure.

The wind load generation unit is configured to generate a wind load by using a random wind field generated by a Kaimal spectrum.

The buffeting wind force calculation unit is configured to calculate buffeting wind force based on the wind load.

The different damage condition simulation unit is configured to simulate different damage conditions of the structure through stiffness reduction.

The acceleration response time-history signal acquisition unit is configured to load the buffeting wind force onto the numerical model under different damage conditions to obtain the acceleration response time-history signal at each point of the structure under different damage conditions.

In this specification, each embodiment is described in a progressive manner, and each embodiment focuses on the differences from other embodiments, and the same and similar parts among various embodiments can be referred to each other. As for the system disclosed in the embodiment, since it corresponds to the method disclosed in the embodiment, the description is relatively simple, and the relevant parts can be described in the method section.

In this specification, the principles and embodiments of the present disclosure have been described with reference to specific examples, and the description of the above embodiments is only used to help understand the methodology and concept of the present disclosure: further, for those of ordinary skilled in the art, there may be changes in the specific embodiments and application scope according to the idea of the present disclosure. In conclusion, the contents of this specification should not be construed as limiting the present disclosure.

What is claimed is:

1. A method for detecting structural damage based on NExT-recurrence plots, comprising:
acquiring a time-history signal of an acceleration response at each point of a structure under different damage conditions;
processing the time-history signal of the acceleration response by using a NExT method to obtain cross-correlation function signals of acceleration responses at different structural points;
performing recurrence plot processing on the cross-correlation function signals, and stacking generated recurrence plots to obtain three-dimensional recurrence plots;
dividing the three-dimensional recurrence plots into a training set and a validation set;
training and validating a convolutional neural network model through the training set and the validation set, respectively;
detecting structural damage through a trained convolutional neural network model.

2. The method according to claim 1, wherein the acquiring a time-history signal of an acceleration response at each point of a structure under different damage conditions comprises:
building a numerical model of the structure;
generating a wind load by using a random wind field generated by a Kaimal spectrum;
calculating a buffeting wind force based on the wind load;
simulating different damage conditions of the structure through stiffness reduction;
loading the buffeting wind force onto the numerical model under different damage conditions to obtain the time-history signal of the acceleration response at each point of the structure under different damage conditions.

3. The method according to claim 1, wherein before performing recurrence plot processing on the cross-correlation function signals, the method further comprises:
normalizing the cross-correlation function signals.

4. The method according to claim 1, wherein when an error calculation value of a cost function in the validation set is less than a predetermined target, it is determined that training of the convolutional neural network model is completed.

5. The method according to claim 1, wherein the method further comprises:
generating each three-dimensional recurrence plot with a different average wind speed, a different damage condition and an acceleration response added with white noise of different signal-to-noise ratios, in comparison with the training set and the validation set, to build a testing set;
testing robustness of the trained convolutional neural network model through the testing set.

6. A system for detecting structural damage based on NExT-recurrence plots, comprising:
an acceleration response time-history signal acquisition module configured to acquire a time-history signal of an acceleration response at each point of a structure under different damage conditions;
a cross-correlation function signal acquisition module configured to process the time-history signal of the acceleration response by using a NExT method to obtain cross-correlation function signals of acceleration responses of different structural points;
a three-dimensional recurrence plot determination module configured to perform recurrence plot processing on the cross-correlation function signal, and stack generated recurrence plots to obtain three-dimensional recurrence plots;
a division module configured to divide the three-dimensional recurrence plots into a training set and a validation set;
a training and validation module configured to train and validate a convolutional neural network model through the training set and the validation set, respectively;
a structural damage detection module configured to detect structural damage through a trained convolutional neural network model.

7. The system according to claim 6, wherein the acceleration response time-history signal acquisition module comprises:
a numerical model building unit configured to build a numerical model of the structure;
a wind load generation unit configured to generate a wind load by using a random wind field generated by a Kaimal spectrum;
a buffeting wind force calculation unit configured to calculate buffeting wind force based on the wind load;
a different damage condition simulation unit configured to simulate different damage conditions of the structure through stiffness reduction;
an acceleration response time-history signal acquisition unit configured to load the buffeting wind force onto the numerical model under different damage conditions to obtain the acceleration response time-history signal at each point of the structure under different damage conditions.
